(19) United States
(12) Patent Application Publication
(10) Pub. No.: US 2011/0211497 A1
(43) Pub. Date: Sep. 1, 2011

(54) COMMUNICATION SYSTEM AND COMMUNICATION CONTROL METHOD

(76) Inventors: Shingo Shiga, Tokyo (JP); Toshiyuki Tamura, Tokyo (JP)

(21) Appl. No.: 13/122,267

(22) PCT Filed: Oct. 5, 2009
(86) PCT No.: PCT/JP2009/005167

§ 371 Date: May 19, 2011

(30) Foreign Application Priority Data
Oct. 6, 2008 (JP) 2008-259419
Dec. 25, 2008 (JP) 2008-329150

(51) Int. Cl. H04W 4/16

(52) U.S. Cl. 370/271

(57) ABSTRACT

A communication system which controls communication between a calling terminal connected to a calling-side communication network and a called terminal connected to a called-side communication network. The calling-side communication network includes an access request transfer device that transfers an access request, which has been sent from the calling terminal, to the called-side communication network; an access request cancel notice receiving device that receives an access request cancel notice, which indicates cancellation of the access request, from the called-side communication network; an access-disable terminal information registering device that registers identification information of the calling terminal which sent the access request in an access-disable terminal storage device, based on the received access request cancel notice; and a restriction request information sending device that sends restriction request information, which indicates the identification information of the calling terminal registered in the access-disable terminal storage device, to a communication restriction apparatus which controls restriction for each communication from the calling terminal and stores corresponding restriction information, based on the restriction request information.

### TECHNICAL FIELD

The present invention relates to a communication system and a communication control method as a basis for a multimedia service which includes a voice service on an IP network.

Priority is claimed on Japanese Patent Applications No. 2008-259419, filed Oct. 6, 2008, and No. 2008-329150, filed Dec. 25, 2008, the contents of which are incorporated herein by reference.

### BACKGROUND ART

In accordance with a recent trend using an IP (Internet protocol), an IP-employed system has, of course, been attempted for voice communication systems which representatively use a telephone network. A standardization group called “3GPP” (3rd generation partnership project) for mobile communication performs standardization of IMS (Internet multimedia subsystem) as a basis for a multimedia service which includes a voice service on an IP network. In recent years, a static or fixed IP system known as “NGN” (next generation network) has also been examined.

Current email services have a social problem in which a sender unilaterally sends an email (message) called a spam mail to a receiver, although the receiver does not want to receive the mail. Such a problem may be caused due to a considerable decrease in the communication cost accompanied with generalization of the Internet, or possibility of sending a large quantity of email from a network accessing terminal such as a personal computer which is easily available.

The above IMS, which will be popular in the future, will probably have a similar problem. A technique for protecting users from such a problem which is called SPIT (spam over IP telephony) is called “PUCI” (protection against unsolicited communication for IMS), and examination thereof has been started by 3GPP or the like. The following Patent Document 1 discloses an IMS network system.

### PRIOR ART DOCUMENT

### Patent Document

Patent Document Published Japanese Translation, No. 2007-527633, of PCT International Publication, No. WO2004/071104

### DISCLOSURE OF INVENTION

### Problem to be Solved by the Invention

In light of the above circumstances, an object of the present invention is to provide a communication system and a communication control method which can protect user convenience against a problem relating to the above SPIT.

### Means for Solving the Problem

In order to achieve the above object, the present invention provides a communication system which controls communication between a calling terminal connected to a calling-side communication network and a called terminal connected to a called-side communication network, wherein the calling-side communication network includes:

an access request transfer device that transfers an access request, which has been sent from the calling terminal, to the called-side communication network;

an access request cancel notice receiving device that receives an access request cancel notice, which indicates cancellation of the access request, from the called-side communication network;

an access-disable terminal information registering device that registers identification information of the calling terminal which sent the access request in an access-disable terminal storage device, based on the received access request cancel notice; and

a restriction request information sending device that sends restriction request information, which indicates the identification information of the calling terminal registered in the access-disable terminal storage device, to a communication restriction apparatus which controls restriction for each communication from the calling terminal and stores corresponding restriction information; based on the restriction request information.

In a typical example of the communication system:

based on the received access request cancel notice, the access-disable terminal information registering device associates the identification information of the calling terminal which sent the access request with identification information of each called-side communication network which sent the access request cancel notice as a combination, and registers the associated combinations in the access-disable terminal storage device; and

the restriction request information sending device sends the restriction request information to the communication restriction apparatus in accordance with the number of the associated combinations between the identification information of the calling terminal which sent the access request and the identification information of each called-side communication network which sent the access request cancel notice.

In a preferable example of the communication system, the communication restriction apparatus comprises:

a subscriber database that stores the restriction request information sent by the restriction request information sending device; and

a restriction request information reading accepting device that accepts a request for reading the restriction request information stored in the subscriber database.

The present invention also provides a communication control method used in a communication system which controls communication between a calling terminal connected to a calling-side communication network and a called terminal connected to a called-side communication network, wherein:

an access request transfer device in the calling-side communication network transfers an access request, which has been sent from the calling terminal, to the called-side communication network;

an access request cancel notice receiving device in the calling-side communication network receives an access request cancel notice, which indicates cancellation of the access request, from the called-side communication network;

an access-disable terminal information registering device in the calling-side communication network registers identification information of the calling terminal which sent the access request in an access-disable terminal storage device, based on the received access request cancel notice; and

a restriction request information sending device in the calling-side communication network sends restriction request information, which indicates the identification information of the calling terminal registered in the access-disable terminal storage device, to a communication restriction apparatus which controls restriction for each communication from the calling terminal and stores corresponding restriction information, based on the restriction request information.

In a typical example of the communication control method:

based on the received access request cancel notice, the access-disable terminal information registering device in the calling-side communication network associates the identification information of the calling terminal which sent the access request with identification information of each called-side communication network which sent the access request cancel notice as a combination, and registers the associated combinations in the access-disable terminal storage device; and

the restriction request information sending device in the calling-side communication network sends the restriction request information to the communication restriction apparatus in accordance with the number of the associated combinations between the identification information of the calling terminal which sent the access request and the identification information of each called-side communication network which sent the access request cancel notice.

In a preferable example of the communication control method:

the communication restriction apparatus in the calling-side communication network includes a subscriber database and a restriction request information reading accepting device;

the subscriber database stores the restriction request information sent by the restriction request information sending device; and

the restriction request information reading accepting device accepts a request for reading the restriction request information stored in the subscriber database.

### Effect of the Invention

In accordance with the present invention, since a message which clearly indicates a disconnection by means of the operation of PUCI, and an addressee (telephone number or URL for the release request) to be accessed so as to release the registration as a bad caller are both communicated to the caller, it is possible to assist acquisition of information for recognizing a fact that the caller itself has been registered as a bad caller and for releasing such registration.

Also in accordance with the present invention, an interface between a calling-side HSS and a called-side IMS entity is newly defined so that the calling-side HSS can send the called side a request for releasing each subscriber who has been registered as a bad caller.

Accordingly, a subscriber who has corrected a target deficiency can inform the operator who has contracted the subscriber of the correction, and (a person in charge of) the operator can send a release request from the HSS through a maintenance and management system to each system in which the subscriber has been registered as a bad caller, thereby automatically issuing a release request for the subscriber who has been registered as a bad caller.

Also in accordance with the present invention, the present operator (communication carrier) can know information of a subscriber who belongs to the present operator and has been registered as a bad caller by another operator. Therefore, a further restriction may be imposed on a subscriber who has troubled another operator. Accordingly, it is possible to prevent a case in which not only is a spam call issued, but also the relevant network is affected by means of virus infection or the like.

### BRIEF DESCRIPTION OF THE DRAWINGS

FIG. 1 is a block diagram showing the structure of an IMS network system.

FIG. 2 is a second block diagram showing the structure of an IMS network system.

FIG. 3 is a third block diagram showing the structure of an IMS network system.

FIG. 4 is a diagram showing an operation flow of some devices in the IMS network system.

### MODE FOR CARRYING OUT THE INVENTION

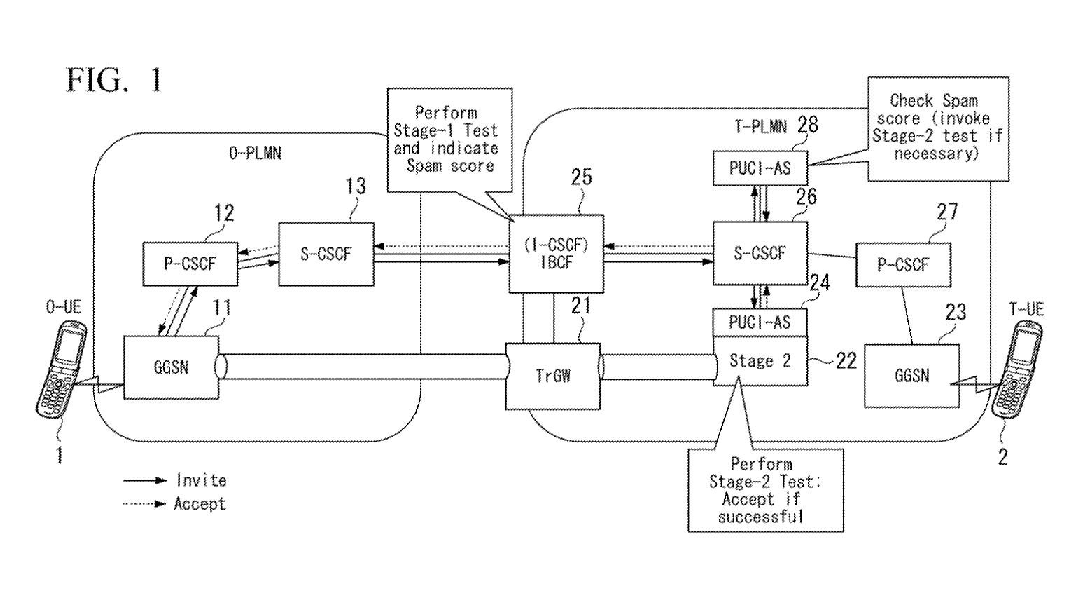

FIG. 1 is a block diagram showing the structure of an IMS network system as an embodiment of the present invention.

The above FIG. 1 is a schematic diagram for an IMS network which employed PUCI. Before explaining the shown structure which solves target problems examined in PUCI, the operation concept of PUCI will be briefly explained below.

The leftmost O-UE indicates a calling terminal (i.e., originating UE), and the rightmost T-UE indicates a called terminal (i.e., terminating UE).

When the O-UE issues a call, a SIP INVITE message is issued for a SIP-URI (session initiation protocol-universal resource identifier) of the T-UE. This message is relayed in routing by an IMS of a calling-side mobile communication network called O-PLMN (public land mobile network), and received by a called-side mobile communication network called T-PLMN.

In IMS network systems, communication is performed using a SIP protocol. The above SIP-URI is an identifier on the SIP protocol, which is allocated to the O-UE or T-UE so as to identify the relevant O-UE or T-UE.

The O-UE tries to issue a call by sending the INVITE message to the SIP-URI of the T-UE. The INVITE message is first sent from the O-UE via a GGSN (gateway GPRS (general packet radio service) support node) 11 to a P-CSCF (proxy call session control function) part 12 (as-a SIP server), and then relayed by the IMS of the O-PLMN on the calling side, so that it arrives at the T-PLMN on the called side.

An IBCF (I-CSCF) part 25, that is, an interconnect border control function (interrogating call session control function) part positioned at the entrance of the called side checks the reliability of a terminal which issued a call by any method (e.g., checks the probability that this call is the above-described SPIT), and writes information of a determined result or the like onto a header portion of the SIP INVITE message.

Such a passive operation of determining a calling party will be called a “Stage 1 test” below.

After that, the INVITE message is sequentially transferred between nodes inside the called-side IMS, and transmitted to an S-CSCF (service call session control function) part 26 which controls the T-UE.

The S-CSCF part 26 refers to the information stored in the INVITE message. If the S-CSCF part 26 determines that the relevant call is the SPIT and thus is worthless for reception, the S-CSCF part 26 can reject receiving the call without transferring the call to the relevant terminal. On the contrary, if the call is determined to be a good call to be received, the INVITE message is transferred to the relevant terminal, so that the call reception is completed.

In addition, a PUCI-AS (application server) 24 can be connected to the S-CSCF part 26, by which an optional determination logic can be added. That is, a test involving the calling side may be performed by, for example, observing a reaction to an intentional failure for call reception, or implementing an additional button operation. Such a test will be called a “Stage 2 test” below.

As described above, in the PUCI, no specific call control on the calling side (O-PLMN) is defined, and the called side (T-PLMN) performs various controls for defending against the SPIT by means of a CSCF part and a PUCI-AS which are entities for processing each call.

For the above-described IMS network system, the present embodiment has:

<1> Function of feeding information back to the caller for a call whose reception has been restricted through PUCI.

In the PUCI specification, the called side avoids a spam call by spontaneously registering the relevant caller as a bad caller, and rejecting future calls from the caller. In such a case, a caller who has repeatedly issued a call to the same addressee innocently so as to reserve a ticket or the like may be insidiously registered as a bad caller through the PUCI function.

In the current PUCI operation, when reception of a call is rejected by PUCI, the caller is communicated of the session interruption through a message (e.g., SIP error response message) which indicates rejection of the call reception. Therefore, such a case cannot be distinguished from a general failure of the call reception, which may be inconvenient for a good user on the calling side.

In also consideration of such a case, convenience can be further improved by providing a function of informing a caller that the caller has been registered as a bad caller, and a method of releasing such registration as a bad caller.

Therefore, it is possible for a user to know that the user has been registered as a bad caller and to obtain information for releasing such registration by incorporating (i) a message which indicates that PUCI performed the interruption, and (ii) an addressee (telephone number or URL) to be accessed so as to release the registration as a bad caller into a message (e.g., SIP error response message) which indicates rejection of the call reception.

For the above-described IMS network system, the present embodiment also has:

<2> Function of collecting (by the calling side) information items for bad callers acknowledged by the called side, and making a calling-side operator collectively issue requests for releasing the relevant registrations.

When a terminal is invaded by a virus or has a trouble, it may issue lots of IMS calls with no intention of the owner of the terminal, and be registered as a bad caller by a plurality of operators.

Even though the owner has killed the virus or performed updating to a software version having no problem, the owner needs to individually ask each of the plurality of the operators so as to release the bad-caller information, which is inconvenient for users.

When a called-side operator is asked to release the bad-caller registration based on information obtained by the above function <1>, the called-side operator has to absorb a cost for handling a problem of the calling-side operator who may be bad, and there is room for improvement in the distribution of cost. Additionally, even when the owner of the relevant terminal asks the operator who has contacted the owner about the problem, only the called-side operator can release the target registration, which is inconvenient for customer support in the relevant operation.

When the above function <1> is implemented, each calling-side IMS entity (e.g., CSCF part) is able to determine that a subscriber has been registered by the called side as a bad caller, obtain information indicating which subscriber is rejected, and which network rejects the subscriber, and store the obtained information in a subscriber database (e.g., HSS (home subscriber server)).

Therefore, an interface between a calling-side HSS and a called-side IMS entity is newly defined so that the calling-side HSS can send the called side a request for releasing each subscriber who has been registered as a bad caller.

Accordingly, the above-described problem can be solved when a subscriber who has corrected a target deficiency informs the operator who has contracted the subscriber of the correction, and (a person in charge of) the operator sends a release request from the HSS through a maintenance and management system to each system in which the subscriber has been registered as a bad caller.

For the above-described IMS network system, the present embodiment also has:

<3> Function of imposing a further usage restriction on a bad caller.

By using the above function <2>, the present operator can know information of a subscriber who belongs to the present operator and has been registered as a bad caller by another operator. Therefore, a further restriction may be imposed on a subscriber who has troubled another operator. Accordingly, it is possible to prevent a case in which not only is a spam call issued by means of virus infection or the like, but also the relevant network is affected.

That is, a chain of ill effects can be terminated by performing, for example:

(i) rejection of mobility management (forcible disconnection or detachment);
(ii) rejection of connection to a specific network;
(iii) rejection of an access to a non-IMS service (e.g., Web service) from a user to whom PUGI has applied a restriction, where the rejection is performed in cooperation with a server of the non-IMS service;
(iv) rejection of issuing an IMS call, or transfer the call to another addressee (e.g., of a window for solving problems); or
(v) rejection of “IMS Registration”

The above functions <1> to <3> will be further explained in detail.

The Above Function <1> of Feeding Information Back to the Caller for a Call Whose Reception Has been Restricted Through PUCI

For the above function <1>, the I-CSCF, P-CSCF, and S-CSCF entities on the called side perform distinctive operations.

When rejecting a call which failed a PUCI test, the above CSCF parts on the called side send a calling-side IMS entity a message (e.g., SIP error response message) which indicates rejection of the call reception. In this process, information which indicates the rejection by PUCI and a telegraphic message which indicates an addressee to be accessed so as to release the relevant registration are added to the corresponding SIP header. The telegraphic message may be a character string understandable by humans, or a telegraphic message to be understood by the calling terminal.

### Calling Terminal

When a message (e.g., SIP error response message) which indicates rejection of reception of a call issued from a calling terminal is returned to the calling terminal, the calling terminal tries to read information which is included in the corresponding header and relates to PUCI.

When information relating to PUCI (i.e., PUCI-related information) is included in the relevant response message, if the message is understandable by humans, the message may be displayed on a screen. If the message is a telegraphic message having a format understandable by the terminal, a button operation or the like may be performed on the terminal so as to access an addressee (of a Web site or a customer center) so as to directly release the relevant registration.

### Calling-Side IMS Entity (P-CSCF and S-CSCF)

The calling-side IMS entities do not modify the PUCI-related information in the SIP message sent from the called side.

### The Above Function <2> of Collecting (by the Calling Side) Information Items for Bad Callers Acknowledged by the Called Side, and Making a Calling-Side Operator Collectively Issue Requests for Releasing the Relevant Registrations

For the above function <2>, the P-CSCF and S-CSCF entities on the calling side perform distinctive operations.

When the entities obtain a result of issuance of a call from a subscriber and the result indicates restriction of the call reception by means of PUCI, the relevant information is extracted and sent to the HSS.

### HSS on Calling Side

It stores information obtained by CSCF, and sends a release request signal to an addressee (which has been stored) for the release request when detecting a data input operation (as a trigger) of a person in charge of maintenance.

### CSCF Part, PUCI-AS, and Other PUCI-Related Devices on Called Side

They check the release request signal received from the calling-side HSS. If the signal is proper, the registration (in the present network) for the relevant subscriber as a bad subscriber is released.

### The Above Function <3> of Imposing a Further Usage Restriction on a Bad Caller

For the above function <3>, the HSS entity on the calling side performs a distinctive operations.

It determines whether or not a further restriction is necessary, based on stored spam action information of the relevant subscriber. If a further restriction is necessary, implementation thereof is tried by sending a restriction request signal to a peripheral node by means of the following devices.

### (1) Exchange (e.g., SGSN, GGSN, or EPC System)

It forcibly disconnects a specific subscriber when receiving a location registration cancel (or cancellation) request signal (e.g., cancel location signal) from a node (e.g., HSS or HLR (home location register)) which manages subscribers.

In another example, it rejects a PDN (packet data network) access request signal (i.e., a request signal for accessing an external network) from a specific subscriber when receiving a restriction request signal from HSS, so that a bad subscriber cannot access the relevant network.

### (2) IMS Entity (CSCF)

When receiving a restriction request signal from HSS, it may reject call connection, transfer the relevant call to a problem handling window of the relevant operator, or reject registration to IMS (i.e., reject “REGISTER”) so as to reject providing a service such as a voice call.

### (3) Another Web Server Device or the Like

When receiving a restriction request signal from HSS, it may reject information service from the relevant Web server, or forcibly display a problem handling Web page of the corresponding operator.

Below the above function <3> (of imposing a further usage restriction on a bad caller) will be explained in detail.

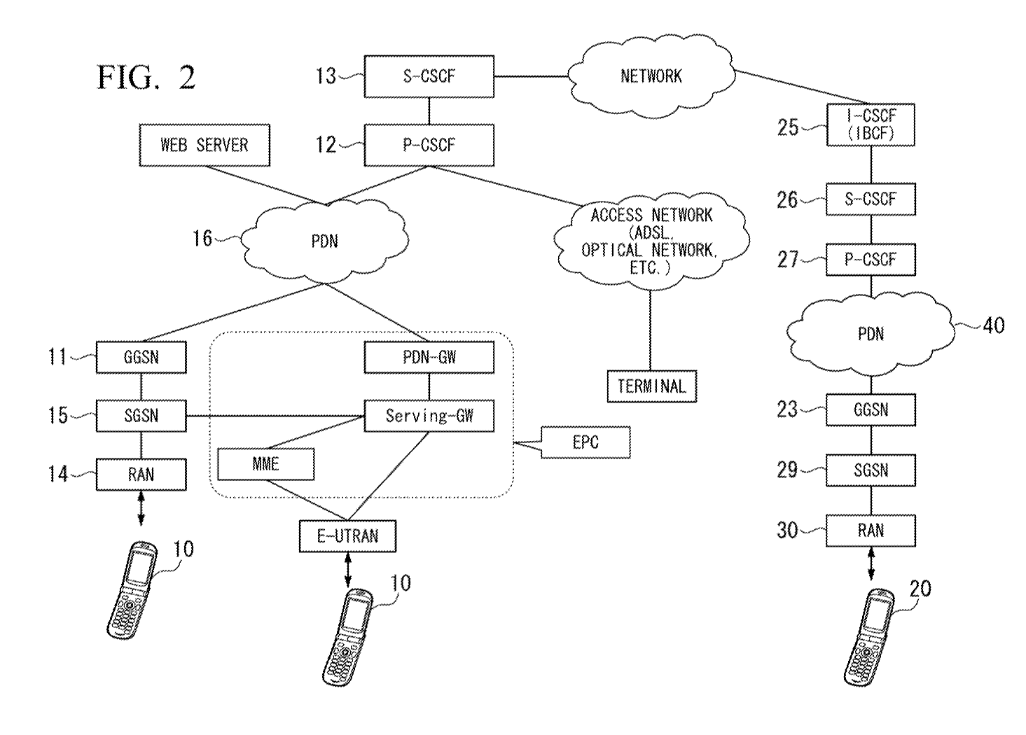

FIG. 2 is a second block diagram showing the structure of the IMS network system. This diagram shows the structure of the IMS network system in FIG. 1 in more detail.

As shown in FIG. 2, in the IMS network system, a calling terminal 10, an RAN (radio access network) 14, an SGSN (serving GPRS (general packet radio service) support node) 15, a GGSN (gateway GPRS support node) 11, a P-CSCF (proxy call session control function) part 12, and a S-CSCF (serving call session control function) part 13 are connected via a communication network, thereby forming a calling-side communication network.

In the calling-side communication network, the GGSN 11 and the P-CSCF part 12 are connected via a PDN (packet data network) 16.

Additionally, in the IMS network system, a called terminal 20 (corresponding to a T-UE), a RAN (radio access network) 30, an SGSN 29, a GGSN 23, a P-CFCS part 27, a S-CSCF part 26, and an I-CSCF (interrogating call session control function) part 25 are connected via a communication network, thereby forming a called-side communication network.

In the called-side communication network, the GGSN 23 and the P-CSCF part 27 are connected via a PDN (packet data network) 40.

Instead of using access networks corresponding to RANs 14 and 30 and access network nodes corresponding to SGSNs 15 and 29 and GGSNs 11 and 23 provided between the calling terminal 10 and P-CSCF part 12 and between the called terminal 20 and P-CSCF part 27, a communication network using a group of servers and a group of gateways such as an E-UTRAN (evolved universal terrestrial radio access network), an MME (mobility management entity), a Serving-GW (gateway), and a PDN-GW (gateway) may be employed so as to form an IMS network system.

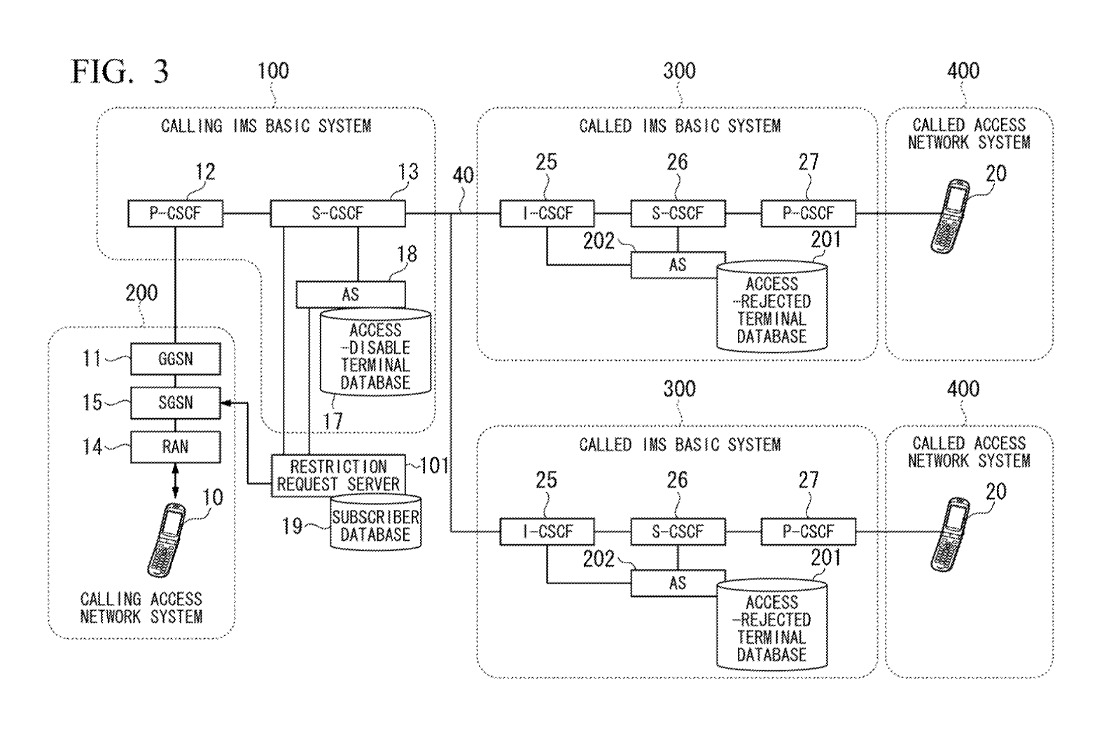

FIG. 3 is a third block diagram showing the structure of the IMS network system.

Referring to FIG. 3, an example of the structure of the IMS network system will be explained. FIG. 3 shows a structure obtained by further simplifying the IMS network system in FIG. 2 for convenience of explanations.

As shown in FIG. 3, the IMS network system is divided into a calling-side communication network and a called-side communication network. The calling-side communication network consists of a calling IMS basic system 100 and a calling access network system 200, and the called-side communication network consists of a called IMS basic system 300 and a called access network system 400.

In order to show that the calling-side communication network can be connected to a plurality of the called-side communication networks, FIG. 3 shows two called IMS basic systems 300 and two called access network systems 400.

The calling access network system 200 includes RAN 14, SGSN 15, and GGSN 11, and the calling IMS basic system 100 includes P-CSCF part 12, S-CSCF part 13, and an application server 18 (as a restriction request information sending device) and an access-disable terminal database (DB) 17 which are connected to S-CSCF part 13.

In addition, as shown in FIG. 3, a restriction request server 101 (as a communication restriction apparatus and a restriction request information reading accepting device) and a subscriber database (DB) 19 (as a communication restriction apparatus) are connected to the calling IMS basic system 100.

The called IMS basic system 300 includes I-CSCF part 25, S-CSCF part 26, P-CSCF part 27, and an application server 202 and an access-rejected terminal database (DB) 201 which are connected to I-CSCF part 25 and S-CSCF part 26.

In simplified FIG. 3, only the called terminal 20 is shown in each called access network systems 400. However actually, as shown in FIG. 2, the called terminal 20 is connected to S-CSCF part 26 via RAN 30, SGSN 29, GGSN 23, and a PDN, similar to the calling access network system 200.

In the present embodiment, the called-side communication network is operated using a communication carrier which differs from that of the calling-side communication network, and thus, S-CSCF part 13 in the calling-side communication network is connected to I-CSCF part 25 in the called-side communication network. However, if the called-side communication network and the calling-side communication network are operated using the same communication carrier, S-CSCF parts of both communication networks are connected directly to each other.

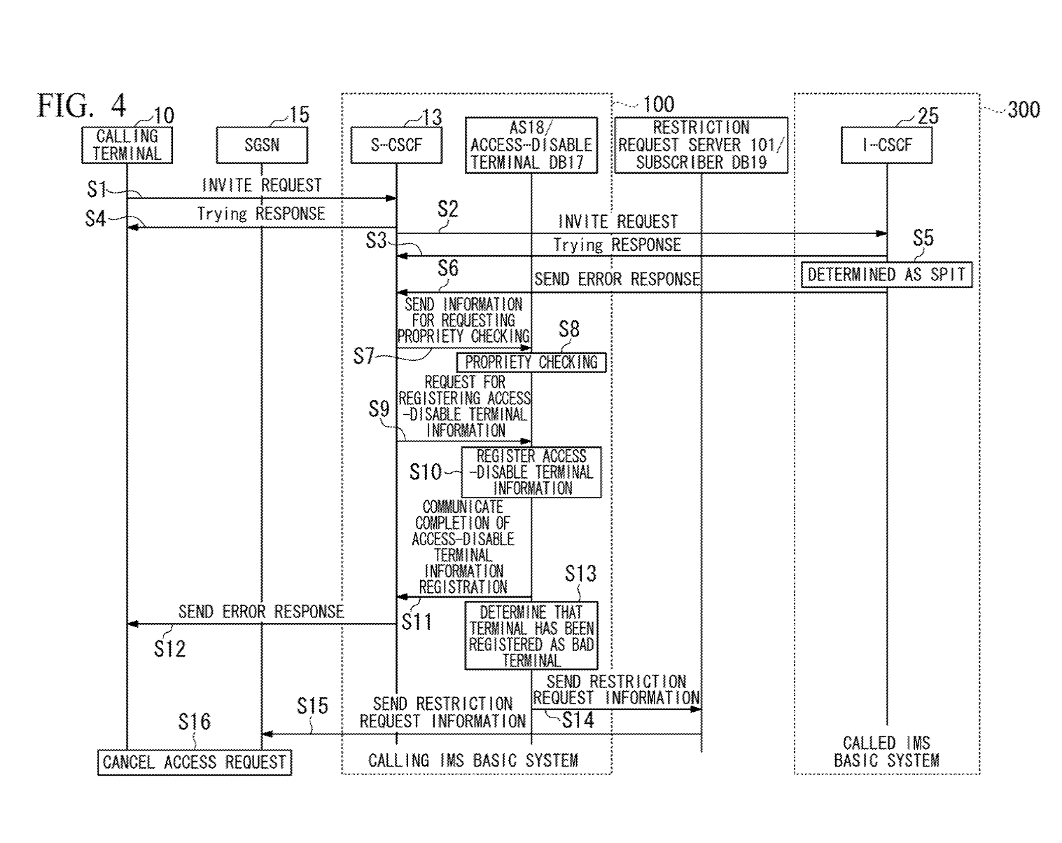

FIG. 4 is a diagram showing an operation flow of some devices in the IMS network system.

Referring to FIG. 4, an operation flow of the devices in the IMS network system will be explained.

First, when the calling terminal 10 sends an INVITE request, the request is received by P-CSCF part 12 (as an access request transfer device) via the calling access network system 200. The P-CSCF part 12 transfers the INVITE request to S-CSCF part 13 (as an access request transfer device), which then receives the INVITE request (see step S1).

In addition, the S-CSCF part 13 detects the SIP-URI of the calling terminal 10, and also detects the SIP-URI of I-CSCF part 25 (in the called-side communication network) as an addressee which has been stored in the application server 18 or the like in association with the SIP-URI of the calling terminal 10. The S-CSCF part 13 sends the INVITE request to the IP-URI of I-CSCF part 25 (see step S2).

When I-CSCF part 25 and S-CSCF part 13 each receive the INVITE request, they each return a Trying response to the device which sent the relevant INVITE request (see steps S3 and S4).

When I-CSCF part 25 in the called-side communication network returns the Trying response via step S3, it issues an inquiry for SPIT (spam over IP telephony) determination (see step S5).

In the SPIT determination, l-CSCF part 25 may retrieve the combination of SIP-URIs of the calling terminal 10 and the called terminal 20 stored in the INVITE request, and send the application server 202 information about the inquiry for the SPIT determination, where the information contains the above combination of SIP-URIs.

The application server 202 returns a result response to l-CSCF part 25 based on information stored in the access-rejected terminal database 201, a memory, or the like.

More specifically, SPIT may be determined when the access-rejected terminal database (DB) stores information (in association with the SIP-URI combination) which indicates whether the relevant access is approved or disapproved, and the information indicates that the access is disapproved (such disapproval information is stored by any method). In another example, SPIT may be determined by the application server 202 when mechanically repeated sending (e.g., for every 5 minutes) of INVITE request for the detected SIP-URI combination is observed in a table of past INVITE requests.

If I-CSCF part 25 determines, based on the inquiry for the SPIT (spam over IP telephony) determination, that the relevant INVITE request is a signal which indicates SPIT, I-CSCF part 25 directs the application server 202 to register information for identifying the calling terminal 10 (e.g., SIP-URI of the calling terminal 10) which sent the INVITE request in the access-rejected terminal database 201, as information which indicates that the relevant calling terminal is an improper calling terminal which performed SPIT operation and a target for cancelling future INVITE requests (as access requests).

In addition, I-CSCF part 25 sends an error response (as an access request cancel notice) to S-CSCF part 13 (as an access request cancel notice receiving device) (see step S6).

The error response stores information of an addressee to be accessed so as to release the access request cancel registration. The addressee may be a mail address or a telephone number of a Web server or a contact center.

Additionally, identification information for the calling terminal or the called-side communication network, or information about a start time or duration for the restriction may also be included (in the error response) as error information.

If I-CSCF part 25 determines in the SPIT determination that the INVITE request is not a signal which indicates SPIT, I-CSCF part 25 performs a conventional normal operation that sends the INVITE request to the called terminal 20 via P-CSCF part 27 in the called-side communication network.

When S-CSCF part 13 receives the error response sent from I-CSCF part 25, it performs a process for checking propriety of the error response.

In the above propriety checking, S-CSCF part 13 may send the application server 18 connected to itself, information for requesting propriety checking about I-CSCF part 25 indicated (in the error response) as the sender of the error response (see step S7), and the application server 18 may determine, based on the information for requesting propriety checking, (i) whether information for node identification (such as an IP address or host name of I-CSCF part 25) or SIP-URI for an error session has been stored, or (ii) whether the structure or content of the corresponding SIP header has consistency (see step S8).

The above propriety checking may be executed by S-CSCF part 13.

When the propriety of the error response can be confirmed, S-CSCF part 13 detects at least identification information (e.g., SIP-URI) of the calling terminal 10 and identification information (e.g., IP address of the application server 202 in the called-side communication network) of the called-side communication network which has cancelled the access request, which are contained in the error response. The S-CSCF part 13 then sends the application server 18 a request for registering access-disable terminal information which includes a pair of the identification information of the calling terminal 10 and the identification information of the called-side communication network (see step S9). The application server 18 (as an access-disable terminal information registering device) registers the access-disable terminal information in the access-disable terminal database 17 (as an access-disable terminal storage device) or the like (see step S10).

Accordingly, the calling-side communication carrier which manages the calling-side communication network can store information about a called-side communication carrier (which manages a corresponding called-side communication network) which has canceled the relevant access request issued from a calling terminal belonging to the calling-side communication carrier.

After the application server 18 registers the access-disable terminal information, the application server 18 informs S-CSCF part 13 of completion of the registration (see step S11).

The S-CSCF part 13 then transfers the error response to the calling terminal 10 via P-CSCF part 12 (see step S12).

When receiving the error response, the calling terminal 10 displays the information (about an addressee to be accessed (i.e., addressee information), details of the error, etc.) stored in the error response, on a display part or the like.

For the calling terminal 10, information about an addressee to be accessed and error information were displayed in accordance with the above-described operation. Thus, the calling terminal 10 was determined to be a bad terminal due to some problem, and an access request from the calling terminal 10 was cancelled by the called-side communication network.

For example, if a virus software source has intruded into the calling terminal 10, quantities of access requests are issued by processing the virus software, so that the calling terminal 10 may be registered as a bad calling terminal, which performed a SPIT operation and whose future INVITE request as an access request will be cancelled, in the access-rejected terminal database 201 of the called-side communication network.

If such a registration has been performed in a plurality of called-side communication networks, an error response shown in the above-described step S6 is sent from the called-side communication networks, so that in accordance with step S10, a plurality of access-disable terminal information items, which are combinations between the identification information of a specific calling terminal 10 and the identification information of each called-side communication network, are registered in the access-disable terminal database 17.

If the number of such combinations between the identification information of the calling terminal 10 and the identification information of each called-side communication network becomes greater than or equal to a predetermined threshold, that is, if it is determined that the calling terminal 10 has been determined to be a bad terminal in a plurality of different called-side communication networks (see step S13), the application server 18 sends restriction request information which indicates the identification information of the calling terminal 10 to a communication restriction apparatus which performs, based on the restriction request information, (i) restriction control for each communication issued from the calling terminal 10 and (ii) storage of corresponding restriction information (see step S14).

For example, when the restriction request server 101 and the subscriber database 19 are defined as a communication restriction apparatus, the application server 18 sends the restriction request information to the restriction request server 101, which associates the identification information of the calling terminal 10 contained in the restriction request information with restriction information, and registers the associated information in the subscriber database 19.

As the restriction information, prohibition information for communication by means of part or all of applications (telephone, mail, chat, and the like) is registered.

Accordingly, if S-CSCF part 13 receives an access request from the relevant calling terminal 10, S-CSCF part 13 inquires of the restriction request server 10.1 whether or not there is a registered restriction. If the identification information of the calling terminal 10, which is specified based on the access request, has been registered in the subscriber database 19, the restriction request server 101 retrieves from the subscriber database 19, (i) information which indicates that there is a registered communication restriction and (ii) restriction information registered in association with the identification information of the calling terminal 10. The restriction request server 101 sends the retrieved information to S-CSCF part 13. Based on the received information, S-CSCF part 13 rejects the access request from the calling terminal 10, that is, rejects transferring the INVITE request from the calling terminal 10.

In accordance with the above operation, the access request from the calling terminal 10 is independently interrupted in the calling-side communication network, thereby preventing the calling terminal 10 from being registered as a bad terminal in another called-side communication network.

When restricting the communication from the calling terminal 10, S-CSCF part 13 may cancel a new access request other than an access request for an emergency call or addressed to a customer center system, or may forcibly transfer a new access request to the customer center system. Additionally, S-CSCF part 13 may cancel a call addressed to the relevant calling terminal 10.

In another example, restriction request information is sent to SGSN 15 through a cooperative process by the subscriber database 19 and the restriction request server 101 (see step S15).

The SGSN 15 stores the identification information of the calling terminal 10 contained in the restriction request information. If the calling terminal 10 has already been connected to the relevant network, SGSN 15 disconnects the connection. The SGSN 15 also cancel each future access request from the calling terminal 10 (see step S16).

In accordance with the above-described operation, when a calling terminal 10 is registered as a bad terminal in a plurality of called-side communication networks, the calling-side communication network can restrict the access request from the calling terminal 10, so that communication which is not desired by other communication networks can be managed in the calling-side communication network.

As the communication restriction apparatus to which the restriction request information is sent, an independent Web server or the like is possible.

For example, the restriction request server 101 may cooperate with a Web server to send information which commands (i) an alarm display when accessing a Web, or (ii) transfer or redirection to a site which recommends software updating.

The restriction request server 101 may also cooperate with a server used for sending a short message or email, to inform the calling terminal 10 that the terminal has been registered as a bad terminal due to a short message or email.

In addition, the restriction request server 101 may perform different restriction operations in accordance with the number of registered combinations between the identification information of the calling terminal 10 and the identification information of each relevant called-side communication network.

For example, when the number of the registered combinations is within 0 to 2, the restriction request server 101 defines no restriction target, and when the number becomes 3 or 4, the restriction request server 101 requests that S-CSCF part 13 automatically transfer a new voice call issued from the calling terminal 10 to a customer center.

When the number of the registered combinations is within 5 to 7, the restriction request server 101 may request that S-CSCF part 13 cancel a new voice call issued from the calling terminal 10.

When the number of the registered combinations is within 8 to 10, the restriction request server 101 may request that SGSN IS cancel a new packet call (to send email or access a Web) issued from the calling terminal 10.

When the number of the registered combinations exceeds 10 (i.e., 11 or more), the restriction request server 101 may request that SGSN 15 disconnect the calling terminal 10 from the relevant network.

In accordance with the above-described operation, a further restriction for communication is applied to a subscriber who annoys other operators or subscribers, thereby preventing a case in which not only is a spam call issued by means of virus infection or the like, but also the relevant network is affected.

Although the present embodiment employs an INVITE method typically used for voice communication in IMS, the present invention can be applied to any method used in IMS, for example, a REGISTER method of registering the existence of UE to a CSCF part (as SIP server) or a MESSAGE method for sending and receiving text messages.

The device as each entity in the IMS network system includes a computer system.

Each of the above-described processes is stored as a program format in a computer-readable storage medium, and executed when the relevant computer loads and executes the program.

The computer-readable storage medium may be a magnetic disk, a magneto-optical disk, a CD-ROM, a DVD-ROM, or a semiconductor memory. Such a computer program may be provided to a computer via a communication line, and the computer which receives the program may execute the program.

In addition, a program for performing a portion of the above-explained processes may be used. Furthermore, a differential file (i.e., a differential program) to be combined with a program which has already been stored in the computer system may be provided to realize the above processes.

### INDUSTRIAL APPLICABILITY

In accordance with the present invention, since a message which clearly indicates a disconnection by means of the operation of PUCI, and an addressee (telephone number or URL for the release request) to be accessed so as to release the registration as a bad caller are both communicated to the caller, it is possible to assist acquisition of information for recognizing a fact that the caller itself has been registered as a bad caller and for releasing such registration.

Also, in accordance with the present invention, the present operator (communication carrier) can know information of a subscriber who belongs to the present operator and has been registered as a bad caller by another operator. Therefore, a further restriction may be imposed on a subscriber who has troubled another operator. Accordingly, it is possible to prevent a case in which not only is a spam call issued, but also the relevant network is affected by means of virus infection or the like.

### REFERENCE SYMBOLS

1 O-UE (originating UE)
2 T-UE (terminating UE)
10 calling terminal
11 GGSN (gateway GPRS (general packet radio service) support node)
12 P-CSCF (proxy call session control function) part
13 S-CSCF (serving call session control function) part
14 RAN (radio access network)
15 SGSN (serving GPRS (general packet radio service) support node)
16, 40 PDN (packet data network)
17 access-disable terminal database
18, 202 application server
19 subscriber database
101 restriction request server
20 called terminal
21 TrGW (translation gateway)
22 Stage 2 server
23 GGSN (gateway GPRS support node)
24 PUCI-AS (protection against unsolicited communication forlMS-application server).
25 IBCF (interconnect border control function) part, I-CSCF (interrogating call session control function) part
26 S-CSCF (serving call session control function) part
27 P-CSCF (proxy call session control function) part
28 PUCI-AS (protection against unsolicited communication for IMS-application server)
29 SGSN (serving GPRS support node)
30 RAN (radio access network)
201 access-rejected terminal database

1. A communication system which controls communication between a calling terminal connected to a calling-side communication network and a called terminal connected to a called-side communication network, wherein the calling-side communication network includes:
an access request transfer device that transfers an access request, which has been sent from the calling terminal, to the called-side communication network;
an access request cancel notice receiving device that receives an access request cancel notice, which indicates cancellation of the access request, from the called-side communication network;
an access-disable terminal information registering device that registers identification information of the calling terminal which sent the access request in an access-disable terminal storage device, based on the received access request cancel notice; and
a restriction request information sending device that sends restriction request information, which indicates the identification information of the calling terminal registered in the access-disable terminal storage device, to a communication restriction apparatus which controls restriction for each communication from the calling terminal and stores corresponding restriction information, based on the restriction request information.

2. The communication system in accordance with claim 1, wherein:
based on the received access request cancel notice, the access-disable terminal information registering device associates the identification information of the calling terminal which sent the access request with identification information of each called-side communication network which sent the access request cancel notice as a combination, and registers the associated combinations in the access-disable terminal storage device; and
the restriction request information sending device sends the restriction request information to the communication restriction apparatus in accordance with the number of the associated combinations between the identification information of the calling terminal which sent the access request and the identification information of each called-side communication network which sent the access request cancel notice.

3. The communication system in accordance with claim 1, wherein the communication restriction apparatus comprises:
a subscriber database that stores the restriction request information sent by the restriction request information sending device; and
a restriction request information reading accepting device that accepts a request for reading the restriction request information stored in the subscriber database.

4. A communication control method used in a communication system which controls communication between a calling terminal connected to a calling-side communication network and a called terminal connected to a called-side communication network, wherein:
an access request transfer device in the calling-side communication network transfers an access request, which has been sent from the calling terminal, to the called-side communication network;
an access request cancel notice receiving device in the calling-side communication network receives an access request cancel notice, which indicates cancellation of the access request, from the called-side communication network;
an access-disable terminal information registering device in the calling-side communication network registers identification information of the calling terminal which sent the access request in an access-disable terminal storage device, based on the received access request cancel notice; and
a restriction request information sending device in the calling-side communication network sends restriction request information, which indicates the identification information of the calling terminal registered in the access-disable terminal storage device, to a communication restriction apparatus which controls restriction for each communication from the calling terminal and stores corresponding restriction information, based on the restriction request information.

5. The communication control method in accordance with claim 4, wherein:
based on the received access request cancel notice, the access-disable terminal information registering device in the calling-side communication network associates the identification information of the calling terminal which sent the access request with identification information of each called-side communication network which sent the access request cancel notice as a combination, and registers the associated combinations in the access-disable terminal storage device; and
the restriction request information sending device in the calling-side communication network sends the restriction request information to the communication restriction apparatus in accordance with the number of the associated combinations between the identification information of the calling terminal which sent the access request and the identification information of each called-side communication network which sent the access request cancel notice.

6. The communication control method in accordance with claim 4, wherein:
the communication restriction apparatus in the calling-side communication network includes a subscriber database and a restriction request information reading accepting device;
the subscriber database stores the restriction request information sent by the restriction request information sending device; and
the restriction request information reading accepting device accepts a request for reading the restriction request information stored in the subscriber database.

7. The communication system in accordance with claim 2, wherein the communication restriction apparatus comprises:
a subscriber database that stores the restriction request information sent by the restriction request information sending device; and
a restriction request information reading accepting device that accepts a request for reading the restriction request information stored in the subscriber database.

8. The communication control method in accordance with claim 5, wherein:
the communication restriction apparatus in the calling-side communication network includes a subscriber database and a restriction request information reading accepting device;
the subscriber database stores the restriction request information sent by the restriction request information sending device; and
the restriction request information reading accepting device accepts a request for reading the restriction request information stored in the subscriber database.

9. The communication system in accordance with claim 3, further comprising a communication restriction device, wherein:
when the restriction request information is sent from the communication restriction apparatus, the communication restriction device stores the identification information of the calling terminal contained in the restriction request information;
if the calling terminal has already been connected to the called-side communication network, the communication restriction device disconnects the relevant connection; and
the communication restriction device cancels each future access request from the calling terminal.

10. The communication control method in accordance with claim 6, wherein:
when the restriction request information is sent from the communication restriction apparatus, a communication restriction device in the calling-side communication network stores the identification information of the calling terminal contained in the restriction request information;
if the calling terminal has already been connected to the called-side communication network, the communication restriction device disconnects the relevant connection; and
the communication restriction device cancels each future access request from the calling terminal.
